(19) United States
(12) Patent Application Publication
(10) Pub. No.: US 2015/0262220 A1
(43) Pub. Date: Sep. 17, 2015

(54) Dynamic Advertising Based on User Preferences

(71) Applicant: Microsoft Corporation, Redmond, WA (US)

(72) Inventors: Ruofei Zhang, Mountain View, CA (US); Hua Li, Bellevue, WA (US); Tie-Yan Liu, Beijing (CN); Taifeng Wang, Beijing (CN); Feidiao Yang, Beijing (CN)

(73) Assignee: Microsoft Corporation, Redmond, WA (US)

(21) Appl. No.: 14/211,493

(22) Filed: Mar. 14, 2014

(51) Int. Cl. G06Q 30/02

(52) U.S. Cl. CPC G06Q 30/0244; G06Q 30/0276; G06Q 30/0269; G06Q 30/0257

(57) ABSTRACT

Systems and methods for responding to an advertisement request with a personalized advertisement are provided. More particularly, in response to an advertisement request from a requesting computer user, a plurality of candidate advertisements are identified and an advertisement is selected. A plurality of potential modifications for the selected advertisement are then identified. A modification, from the plurality of potential modifications, is selected as a function of a user preference vector associated with the requesting computer user. The user preference vector comprises a plurality of user preference items, each item indicating a likelihood of interaction of the requesting computer user with an advertisement having a modification according to a corresponding preference classification. Modification content corresponding to the selected modification is obtained and the modification content is added the selected advertisement. The modified selected advertisement is returned as a personalized advertisement to the advertisement request.

### BACKGROUND

Much of the content available online (i.e., content accessible to a computer user via a computing device) is “free” to access. Typically, the costs to content publishers of offering online content “for free” is made up by the inclusion of paid advertising. In other words, by including a paid advertisement in the online content, those who access the content are not charged an access fee.

While providing advertisements is known in the art, a brief, general description is provided. Generally speaking, content publishers typically publish content with advertisement space reserved for advertisements (i.e., space in which an advertisement will be placed.) Additionally, these content publishers will contract with an advertisement service to manage the reserved advertisement spaces in the published content, i.e., provide an advertisement to be placed in the reserved advertisement space when the content is requested by and displayed to a computer user. As indicated, this arrangement will include a financial incentive to the content publisher from the advertising service. For its part, the content publisher will include information (code, references, hyperlinks, etc.) in its published content (typically in association with the advertisement space) that will generate an advertisement request to the advertisement service when a computer user retrieves and, more particularly, displays the content.

Advertisers typically try to target those computer users that are most likely to be motivated to act upon an advertisement. As is readily understood, elements that come into play in targeting computer users include demographic information, browsing history, purchase history, existing clients, and the like. By targeting those computer users that are most likely to act or interact with an advertisement, the advertiser improves the return on the cost of advertising. Thus, generally speaking, the more specifically advertisers are able to direct their advertisements to the right market segment, the more the advertiser is willing to pay for placing an advertisement in front of a computer user of that market segment.

In addition to elements that describe an advertised product/service, advertisers often include content in an advertisement that is calculated to induce the computer user to interact with the advertisement. For example, an advertiser may include and phrases such as “lowest price of the year,” or “authorized dealer.” In addition to textual content, an advertiser may include music, video, colors, interactive elements, and the like.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for responding to an advertisement request with a personalized advertisement are provided. More particularly, in response to an advertisement request from a requesting computer user, a plurality of candidate advertisements are identified and an advertisement is selected. A plurality of potential modifications for the selected advertisement are then identified. A modification, from the plurality of potential modifications, is selected as a function of a user preference vector associated with the requesting computer user. The user preference vector comprises a plurality of user preference items, each item indicating a likelihood of interaction of the requesting computer user with an advertisement having a modification according to a corresponding preference classification. Modification content corresponding to the selected modification is obtained and the modification content is added the selected advertisement. The modified selected advertisement is returned as a personalized advertisement to the advertisement request.

According to additional aspects of the disclosed subject matter, a computer-implemented method for responding to an advertisement request from a requesting computer user is provided. According to aspects of the disclosed subject matter, an advertisement request for an advertisement for display to a computer user is received. An advertisement is selected from a plurality of candidate advertisements suitable for responding to the advertisement request. A user preference vector associated with the computer user is accessed and a modification action to be performed on the selected advertisement is determined as a function of the user preference vector. The content of the selected advertisement is modified according to the modification action and information for displaying the modified selected advertisement is returned in response to the advertisement request.

Addition to yet additional aspects of the disclosed subject matter, a computer-readable medium is presented. The computer-readable medium includes computer-executable instructions which, when executed on a computing system comprising at least a processor and a memory, carry out a method for responding to an advertisement request. The method for responding to the advertisement request includes selecting an advertisement from a plurality of advertisements suitable for responding to the advertisement request. A user preference vector associated with the computer user is accessed and a modification action to be performed on the selected advertisement is determined as a function of the user preference vector. The content of the selected advertisement is modified according to the modification action and information for displaying the modified selected advertisement is returned in response to the advertisement request.

According to still further aspects of the disclosed subject matter, an advertisement service implemented on a computer system for responding presenting search results to an advertisement request is presented. The advertisement service includes a processor and a memory, wherein the processor executes instructions stored in the memory as part of or in conjunction with additional components of the advertisement service to respond to the advertisement request. These addition components include an advertisement request interface configured to receive an advertisement request for an advertisement to be presented to a requesting computer user. Additionally, the advertisement service includes an advertisement selector for selecting an advertisement from a plurality of advertisements in an advertisement store in response to the advertisement request. Still further, the advertisement service includes an advertisement modifier. The advertisement modifier identifies a modification from a plurality of modifications to the advertisement as a function of a user preference vector corresponding to the requesting computer user. Additionally, the advertisement modifier identifies obtains modification content from a modification content store and modifies the selected advertisement with the obtained modification content. The selected, modified advertisement is returned in response to the advertisement request.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary network environment suitable for implementing aspects of the disclosed subject matter, particularly in regard to providing personalized advertisements in response to an advertisement request;

FIG. 2 is a state diagram illustrating an exemplary interaction between a computer user, a content publisher, and an advertisement service in providing personalized advertisements;

FIG. 3 is a flow diagram illustrating an exemplary routine for providing a personalized advertisement in response to an advertisement request;

FIG. 4 is a flow diagram illustrating an exemplary routine for personalizing an advertisement in response to an advertisement request from a requesting computer user;

FIG. 5 is a flow diagram illustrating an exemplary routine for generating a user preference vector for a computer user, and FIG. 6 is a flow diagram illustrating an alternative exemplary routine for generating a user preference vector for a computer user;

FIG. 7 is a flow diagram illustrating an exemplary routine for identifying modification content in accordance with aspects of the disclosed subject matter;

FIG. 8 is a block diagram illustrating an exemplary advertisement service implemented on a computer system and suitable for responding to advertisement requests;

FIG. 9 is a block diagram illustrating an exemplary user preference vector, formed in accordance with aspects of the disclosed subject matter

FIGS. 10 and 11 are illustrations of exemplary advertisements, and for illustrating aspects of the disclose subject matter;

FIG. 12 illustrates Maslow's needs mapped as exemplary classifications; and

FIGS. 13A-13C are a pictorial diagrams for illustrating the results of modifying an exemplary advertisement with elements of selected preference classifications, according to aspects of the disclosed subject matter.

### DETAILED DESCRIPTION

For purposes of clarity, the use of the term “exemplary” in this document should be interpreted as serving as an illustration or example of something, and it should not be interpreted as an ideal and/or a leading illustration of that thing.

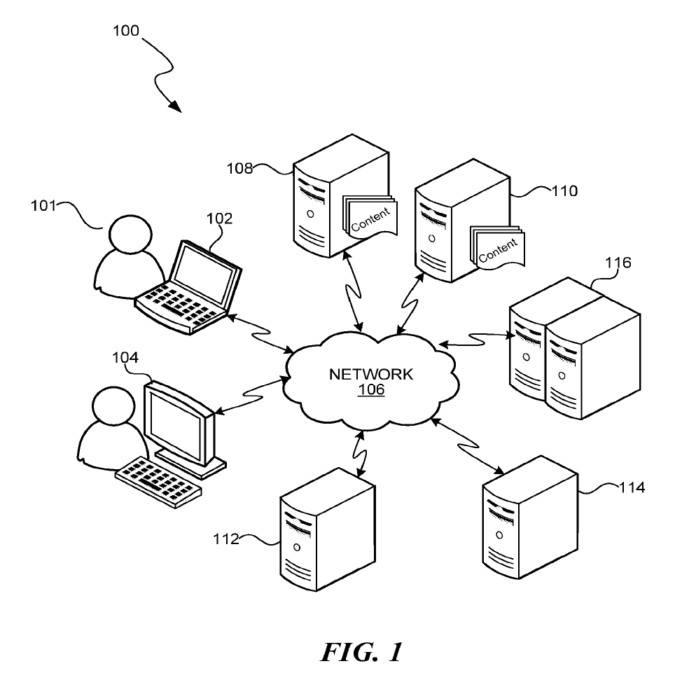

Turning now to FIG. 1, FIG. 1 is a block diagram illustrating an exemplary network environment 100 suitable for implementing aspects of the disclosed subject matter, particularly in regard to providing personalized advertisements in response to an advertisement request. The exemplary networked environment 100 includes one or more user computers, such as user computers 102-104, connected to a network 106, such as the Internet, a wide area network or WAN, and the like. User computers include, by way of illustration and not limitation: desktop computers (such as user computer 104); laptop computers (such as user computer 102); tablet computers (not shown); mobile devices (not shown); game consoles (not shown); personal digital assistants (not shown); and the like.

The exemplary network environment 100 also includes one or more content publishers, such as content publishers 108-110. A content publisher is an entity (including a person, an organization, a business, a service, and the like) that makes content available on the network 106 to others. Content publishers include, by way of illustration and not limitation: search engines and or search provider services; blog sites; news organizations; authors; commercial sale sites; and the like. As suggested above, a computer user, such as computer user 101, retrieves content—that includes space reserved for an advertisement—from a content publisher and displays the content on his/her computer (such as user computer 102), including advertisements that are associated with the content. Further included in the exemplary network environment 100 are advertisers, including advertisers 112-114. Also included in the exemplary network environment 100 one or more advertisement services, including advertisement service 116. The advertisers, such as advertisers 112-114, contract with an advertisement service 116 to provide advertisements in relation to content that a computer user may request from the content publisher.

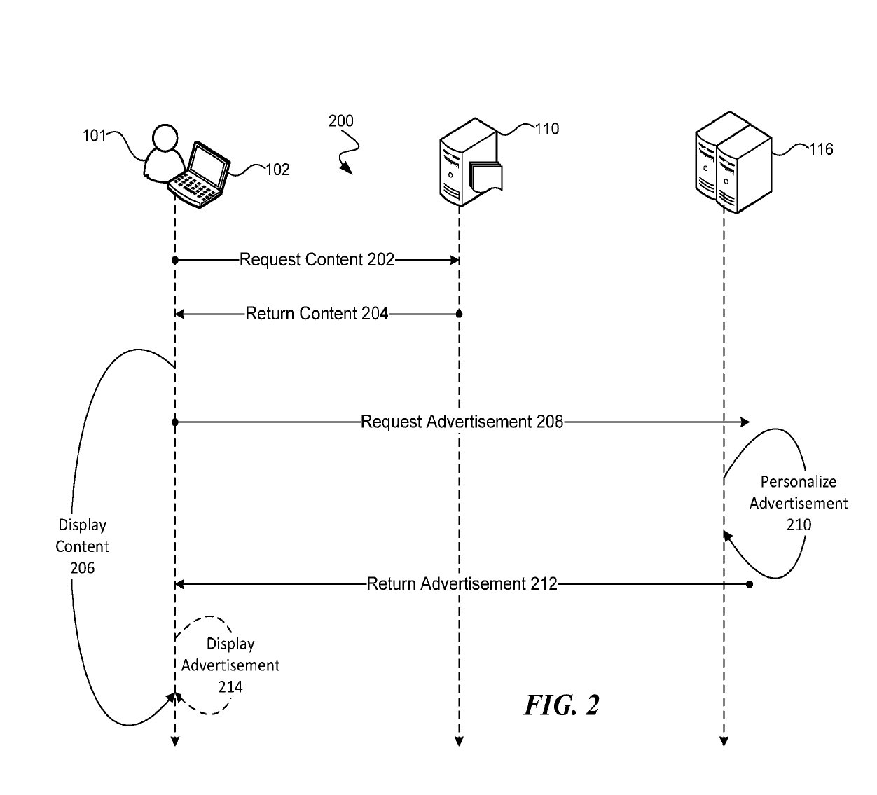

To illustrate the interaction of at least some of the entities of the exemplary networked environment 100, reference is made to FIG. 2. FIG. 2 is a state diagram 200 illustrating an exemplary interaction between a computer user 101 (by way of user computer 102), a content publisher 110, and an advertisement service 116 in providing personalized advertisements. As shown in FIG. 2, the computer user 101 (by way of user computer 102) requests content from a content publisher 110, as indicated by arrow 202. In turn, the content publisher 110 returns the requested content to the computer user 101, as indicated by arrow 204. According to aspects of the disclosed subject matter, the requested content includes advertisement information for obtaining an advertisement from an advertisement service 116.

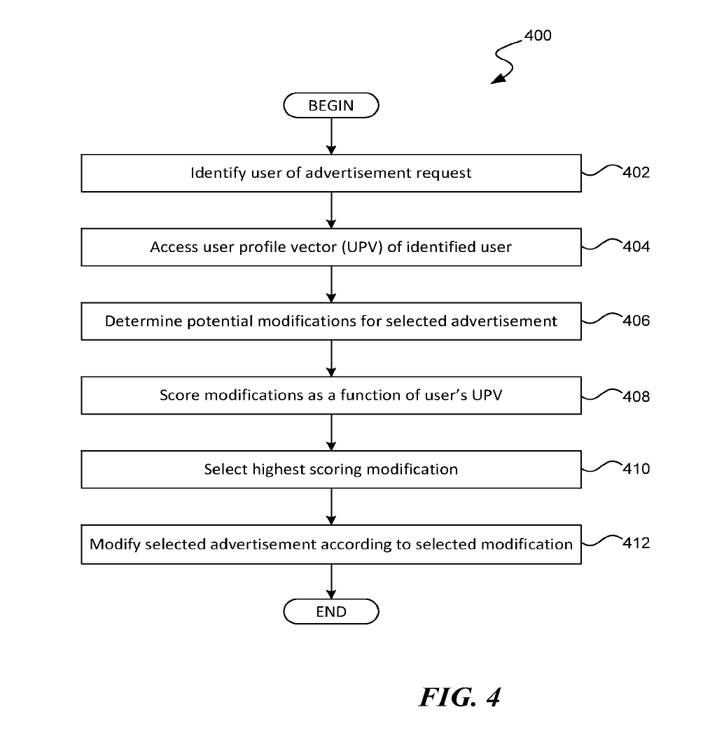

At some point after receiving the requested content, the content is displayed/presented to the computer user 101. As part of displaying or presenting the content to the computer user and because the content includes advertisement information for obtaining an advertisement from an advertisement service 116, an advertisement request is sent to the advertisement service, as indicated by arrow 208. The advertisement request includes information that the advertisement service 116 needs in order to identify a suitable advertisement and personalize the advertisement for the requesting computer user 101. Typically, this information includes (by way of illustration and not limitation) a user identifier (or user identifying information) of the requesting computer user, information identifying the content, and the like. Based on the identifying information of the advertisement request, the advertisement service 116 selects an advertisement to present to the requesting computer user 101. In addition to selecting an advertisement to be presented/displayed to the computer user and according to aspects of the disclosed subject matter, the advertisement service 116 personalizes (i.e., modifies) the selected advertisement, as indicated by arrow 210. This modification is designed to personalize the advertisement in such a manner as it increase the likelihood that the computer user 101 will interact with the advertisement. Personalizing the selected advertisement is discussed in greater detail below in regard to FIG. 4.

After personalizing the selected advertisement, the advertisement is returned to the computer user 101, as indicated by arrow 212. Those skilled in the art will appreciate that returning the advertisement to the computer user 101 may comprise delivering the actual modified content of the advertisement, a link to the modified content of the advertisement, or a combination of delivering some of the modified content with links to addition content to be included as part of the advertisement. On the computer user's computer 102 and as part of displaying the content, the modified/personalized advertisement is displayed in the area of the content reserved for the advertisement, as indicated by dashed arrow 214.

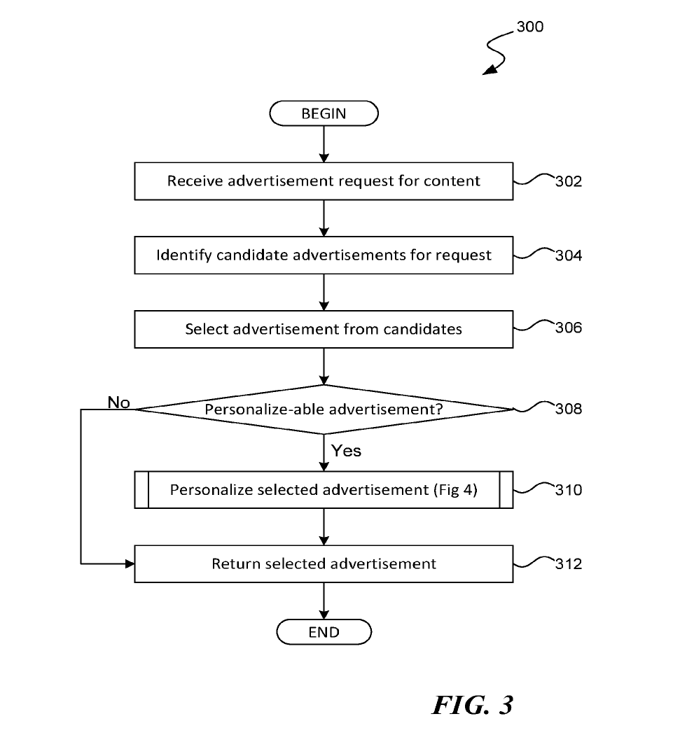

Of course, at least a portion of the interaction described above may be set forth in regard to a routine, such as found in FIG. 3. Indeed, FIG. 3 is a flow diagram illustrating an exemplary routine 300 for providing a personalized advertisement in response to an advertisement request from a computer user, such as computer user 101. The routine 300, is described as may be implemented by a suitably configured advertisement service, such as advertisement service 116. Typically, though not exclusively, the advertisement request is made in conjunction with the display of content to the computer user.

Beginning at block 302, an advertisement request is received from a requesting computer user 101. At block 304, the advertisement service 116 identifies a set of candidate advertisements that may satisfy the advertisement request. As suggested above and as will be appreciated by those skilled in the art, candidate advertisements may be selected according to demographics of the requesting computer user, browsing history, purchase history, existing clients, the subject matter of the content from which the advertisement request is made (e.g., the subject matter of a search query, the subject matter of a blog site, etc.), and the like. At block 306, the advertisement service 116 selects an advertisement from the candidate advertisements. This, too, is a step that is readily appreciated by those skilled in the art. Indeed, the selected advertisement may be selected based on the bid price (to be paid by the advertiser) for placing the selected advertisement in content presented to the computer user 101, advertisement campaign fulfillment goals, advertisement distribution among unique computer users, and the like.

At decision block 308, a determination is made is to whether the selected advertisement is personalize-able, i.e., can be modified and/or personalized to the requesting computer user 101 in order to increase the likelihood of the computer user interacting with the selected advertisement. This determination may be made by the advertisement service 116 according to an analysis of the content of the advertisement, according to information provided by the advertiser submitting the advertisement, or a combination of the two. In the first instance, the advertisement service 116 may analyze the advertisement and, according to preferences of the computer user (as will be discussed below in regard to FIG. 4), modify the content of the advertisement. In the second instance, as part of submitting advertisements to the advertisement service 116, an advertiser may indicate whether or not the advertisement may be modified by the advertisement service 116, and may further including indications as to the manner in which the advertisement may be modified. By way of illustration, the advertiser may indicate one or more preference classifications in which the advertisement may be modified. Preference classifications are discussed in more detail below.

If the determination is made that the selected advertisement may be personalized/modified, at block 310 the advertisement is personalized according to preferences of the requesting computer user. As mentioned already, personalizing the selected advertisement according to preferences of the requesting computer user is set forth below in regard to routine 400 of FIG. 4. However, after personalizing the selected advertisement, of if the advertisement cannot be personalized, the selected advertisement (either the advertisement content and/or references to the advertisement content) is returned to the requesting computer user for presentation to the user. Thereafter, the routine 300 terminates.

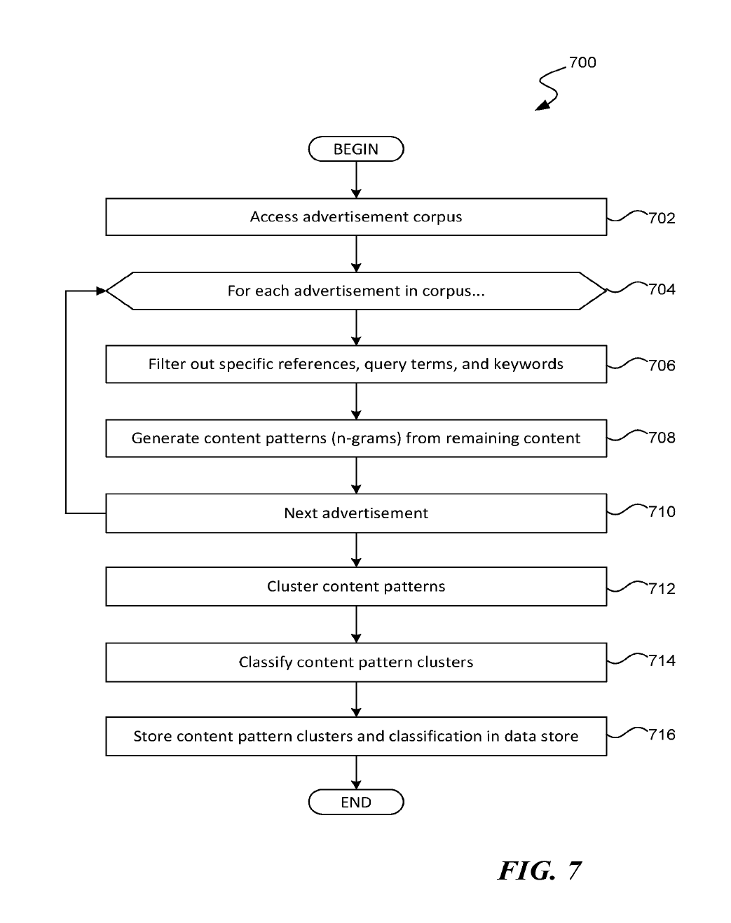

In regard to personalizing a selected advertisement, FIG. 4 is a flow diagram illustrating an exemplary routine 400 for personalizing an advertisement in response to an advertisement request from a requesting computer user. As with routine 300, routine 400 is described in the context of a suitably configured advertisement service 116 implemented on a computer system (such as set forth in regard to FIG. 8.) Beginning at block 402, the identity of the requesting computer user is determined. As mentioned above, the identity of the requesting computer user 101 may be included as part of the advertisement request, or may be determined in other ways such as (but not limited to) the IP address of the requesting computer user. After identifying the computer user 101, at block 402 the user preference vector of the requesting user is accessed. According to various aspects of the disclosed subject matter, the advertisement service 116 maintains a user profile store of user profiles for a plurality of computer users, and the user profiles include a user preference vector.

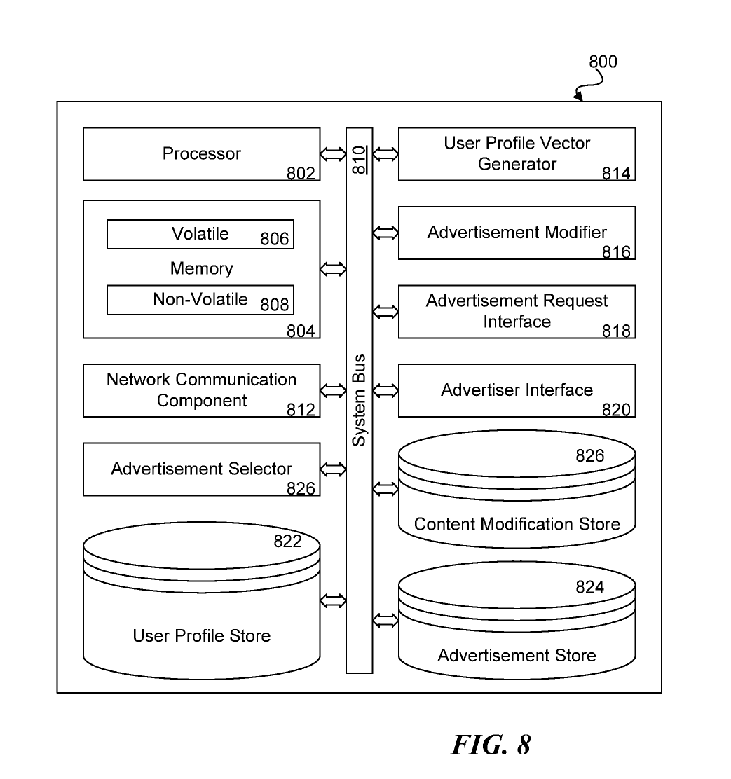

To describe the elements and purpose of the user preference vector, reference is now made in regard to FIG. 9. FIG. 9 is a block diagram illustrating an exemplary user preference vector 900 in accordance with aspects of the disclosed subject matter. As shown in FIG. 9, the exemplary user preference vector 900 includes a plurality of preference classification items C₁-Cₙ. Each preference classification item C₁-Cₙ is associated with one or more preference classifications.

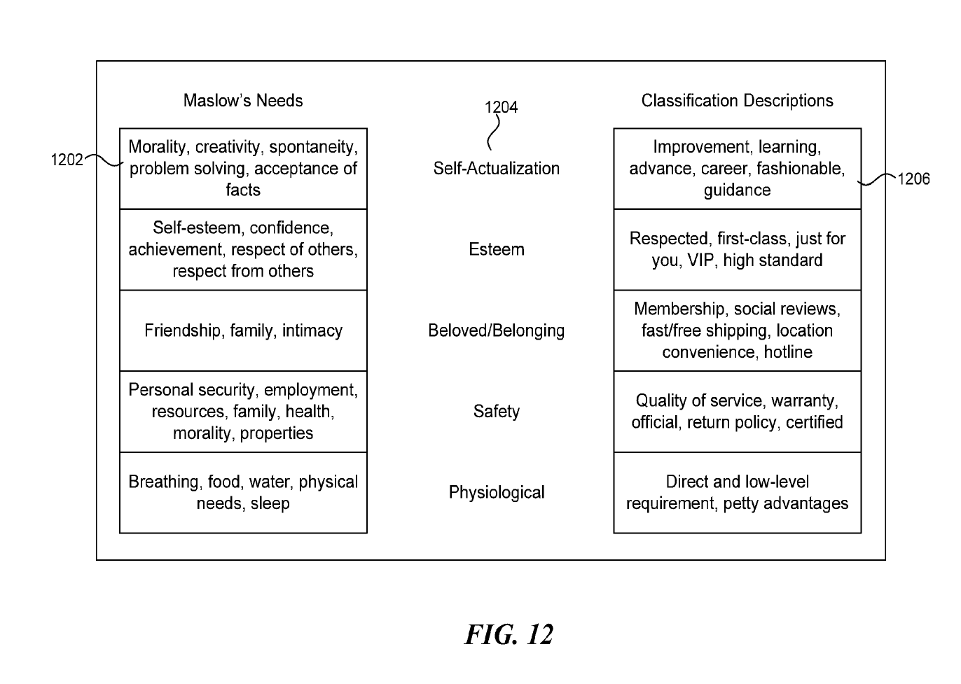

According to aspects of the disclosed subject matter, a preference classification is typically one of a predetermined set of preference classifications, where a preference classification corresponds to a basis or a rationale for which a given user may prefer and/or be motivated to interact with an advertisement having content with the classification. For example, a computer user may be more likely to interact with an advertisement if, with the content of the advertisement, the advertisement includes subject matter that provides an indication that the advertised product is offered by an authorized source. This additional subject matter, the indication that the advertised product is offered by an authorized source, may mapped to a preference classification ontology (comprising a plurality of preference classifications.) By way of illustration (and not limitation) and according to various embodiments of the disclosed subject matter, the preference classification ontology is based on the Maslow's needs classifications. FIG. 12 illustrates a mapping 1200 of Maslow's needs classifications into preference classifications. On the left are the Maslow's Needs, such as “Morality, creativity, spontaneity . . . ”1202. Each of these Needs has a corresponding preference classification, such as preference classification 1204 (Self-Actualization). These preference classifications are listed in the center column of data. On the right, there is a Classification Descriptions column where each classification is described, such as description 1206 corresponding to the “Self-Actualization” preference classification 1204.

As indicated above, a preference classification item C₁-Cₙ (FIG. 9) may be associated with one or more preference classifications. In other words, a preference classification item may indicate a likelihood of interaction with regard to an advertisement having content of multiple preference classifications. For example and with reference to Maslow's Needs as set forth in FIG. 12, an analysis of a user's interactions with advertisements may yield information indicating the likelihood that the user interact with an advertisement having elements of the preference classifications of “self-actualization” and “safety.”

As mentioned in regard to FIG. 9 and according to aspects of the disclosed subject matter, each preference classification item indicates a likelihood of user interaction when an advertisement is presented to the user, the advertisement having content that corresponds to the preference classification (or preference classifications) of the preference classification item. In one embodiment (not shown), this likelihood of interaction may simply be a binary indicator, e.g., a yes/no or a true/false type of indication. A binary indicator indicates whether or not the user is likely to interact with the advertisement having content of the preference classification. However, in an alternative embodiment and as shown in FIG. 9, the likelihood of interaction may correspond to a magnitude of likelihood. In other words, the likelihood of interaction may indicate, on a predetermined scale, the likelihood of interaction of the user to an advertisement having content corresponding to the preference classification (or preference classifications) of the preference classification item. According to one embodiment, the scale may correspond to values from 0.0 to 1.0, where 0.0 indicates that the user is not likely at all to interact with content of the corresponding preference classification, and where 1.0 indicates that the user is most likely to interact with content of the corresponding preference classification (or classifications). Of course, other scales and ranges may be used. Additionally, an unbounded scale may be used, e.g., each value greater than 0.0 corresponds to a particular magnitude of likelihood that the user will interact with an advertisement having content corresponding to the preference classification item's preference classification (or classifications), a magnitude value of 0.0 indicates no preference, and where magnitude values less than 0.0 indicate a likelihood that the user will not will interact with an advertisement having content corresponding to the preference classification item's preference classification.

Returning again to FIG. 4, after having retrieved the user preference vector 900 of the identified computer user 101, at block 406 the potential modifications that can be made to the selected advertisement are determined. As indicated above, these potential modifications may be indicated by the advertiser with regard to the particular advertisement or in general with regard to an advertiser's advertisements, determined according to an analysis of the selected advertisement by the advertisement service 116, or a combination of them.

At block 408, a score for each of the potential modifications is determined. These scores are determined as a function of the computer user's user preference vector. Scores for each the potential modifications may simply be the magnitude value of the corresponding preference classification item. Additionally and/or alternatively, advertisers could associate a modification score with each modification item, such that the potential modification score is a product of the advertiser's modification score and the magnitude of the likelihood of interaction of the corresponding preference classification item. Still further, the advertisement service may associate a preference score with each modification item, such that the score is a product of the associated preference score and the magnitude of the likelihood of interaction of the corresponding preference classification item. In any event, the score for each potential modification is a function of the likelihood of interaction of the corresponding preference classification item.

After having scored the potential modifications as a function of the requesting computer user's user preference vector (UPV) 900, at block 410 the highest scoring potential modification is selected as the modification/personalization to be performed on the selected advertisement.

At block 410, modification content corresponding to the selected modification is obtained. Typically, this modification content is obtained from a modification store accessible and/or maintained by the advertisement service. The modification content is based on preference classification (or classifications) of the highest scoring personalization/modification. According to aspects of the disclosed subject matter, the modification content may correspond to textual content that is viewed as adding the particular quality or basis of the corresponding preference classification (or classifications). For example, if the preference classification item identifies the preference classification as “Safety” (as shown in FIG. 12), then the modification content may include text indicating “authorized dealer.” Of course, other types of content, other than textual content, may also be included. These include graphical images, colors, audio/sound, interactive controls, and the like.

After obtaining the modification content, at block 412 the selected advertisement is modified/personalized. Generally speaking, modification involves adding the modification content into the advertisement content. An analysis may be made (including an analysis made in anticipation of an advertisement request for the selected advertisement) to identify locations within the advertisement to place the modification content. Alternatively, the location for the modification content may be indicated by the advertiser. Thereafter, routine 400 terminates.

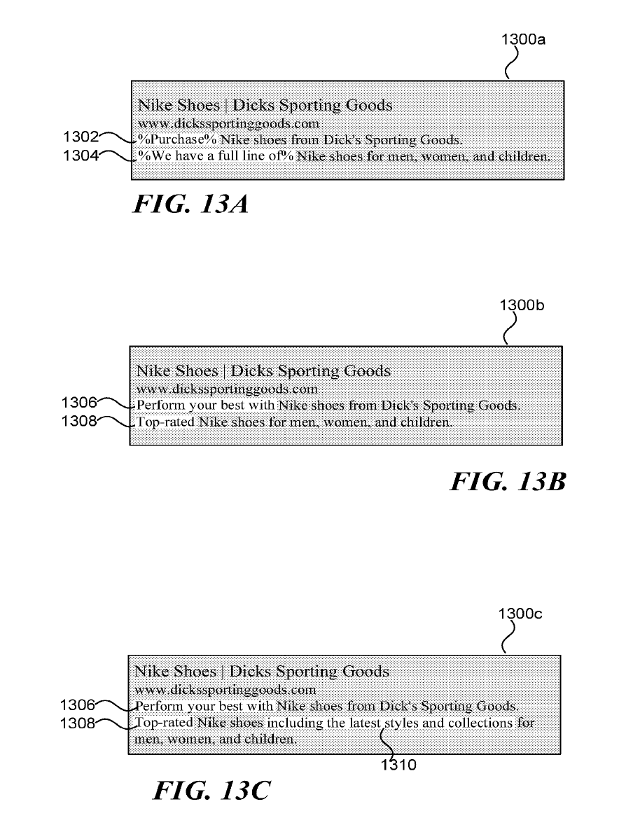

By way of a simple illustration with regard to modifying an advertisement, reference is now made to FIGS. 13A-13C. FIGS. 13A-13C are a pictorial diagrams for illustrating the results of modifying an exemplary advertisement with elements of selected preference classifications, according to aspects of the disclosed subject matter. Beginning with FIG. 13A, this illustrates an exemplary advertisement 1300a as may be presented by an advertiser. Advertisement 1300a includes elements 1302-1304 be identified by an advertiser as potential elements for replacement with modification content selected from classification of the highest scoring personalization/modification.

Turning, now, to FIG. 13B, this illustrates the exemplary advertisement (denoted now as advertisement 1300b) with the advertiser-identified elements 1302-1304 replaced with personalization content 1306-1308 from a preference classification of self-actualization (see classification 1204 of FIG. 12) to suggest that the particular items for sale are top performers and will help the purchaser achieve top performance.

As suggested above, while an advertiser may suggest various modifications, in addition to an advertiser's suggestions, or as an alternative to an advertiser's suggestions, the exemplary process may also locate and add personalization/modifications that are relevant to the user. Indeed, according to various embodiments, an advertiser does not identify any portions within an advertisement to be modified, leaving such modifications to the advertisement service. Thus, turning now to FIG. 13C and with reference to the advertisement (now denoted as advertisement 1300c), in addition to adding personalization content 1306-1308 to the advertisement at the locations that the advertiser suggested, personalization content 1310 has additionally been added to the advertisement, again with regard to self-actualization—suggesting not only top performance but the latest in fashion.

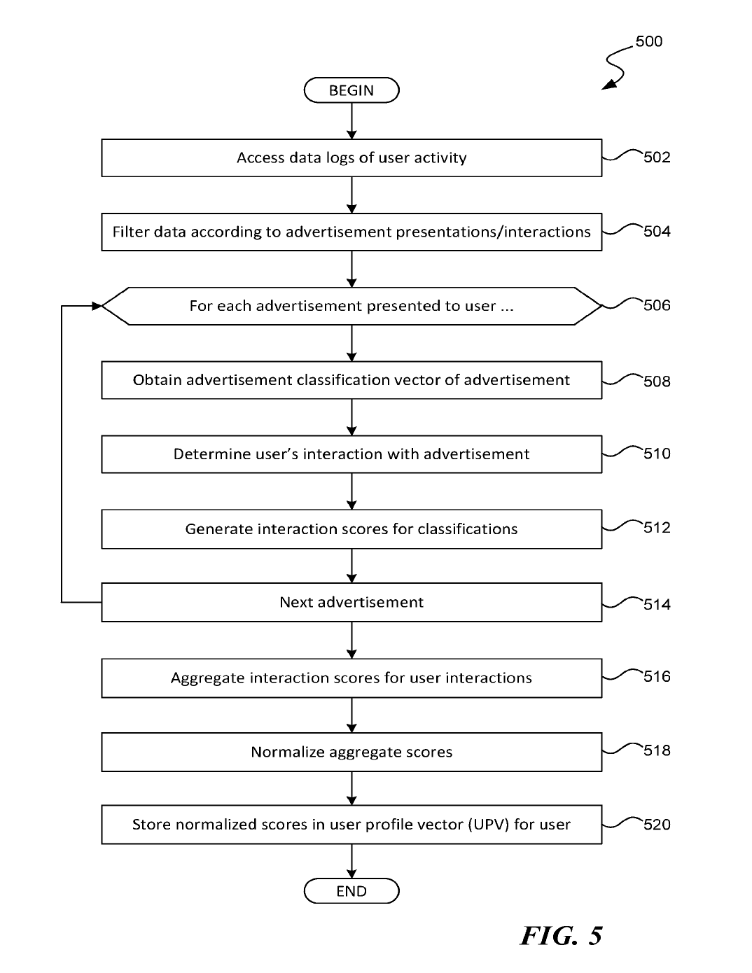

Turning now to FIG. 5, FIG. 5 is a flow diagram illustrating an exemplary routine 500 for generating a user preference vector for a computer user. According to various embodiments, because the advertisement service uses the user preference vector, the exemplary routine may be implemented by/on the advertisement service. However, this is not a requirement as the analysis may be conducted by other services.

Beginning at block 502, data logs of user activity of the computer user are accessed. Generally speaking, the data logs typically correspond to the computer user's online activity, including interactions with advertisements. Accordingly, the data logs may include, by way of illustration and not limitation, the computer user's browsing history, search history, social network interactions, and the like.

At block 504, the data logs are filtered according to advertisement presentations (i.e., advertisements that are presented to the computer user) and computer user interactions with the advertisements, such that only data regarding the presentation of advertisements and the user's interaction with the advertisements remains. At block 506, an iteration loop is begun to iterate through the filtered data to evaluate each of the advertisements presented to (and potential interactions with) the computer user. Thus, at block 508, and advertisement classification vector of the presently iterated advertisement is obtained. According to aspects of the disclosed subject matter, the advertisement classification vector is generated according to an analysis of the content of the advertisement and indicates one or more preference classifications associated with the advertisement.

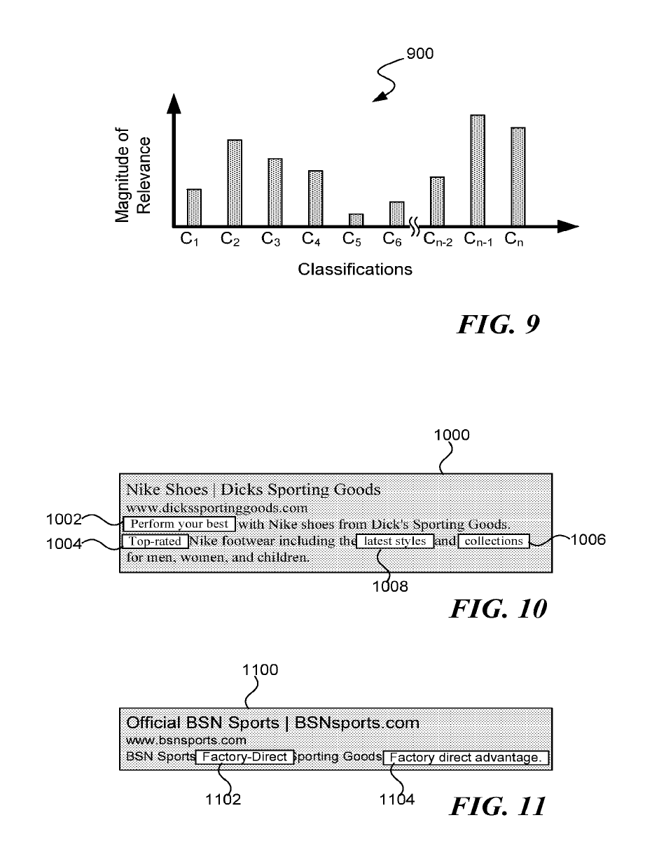

By way of example and with reference to FIGS. 10 and 11, each of which illustrate exemplary advertisements. Advertisement 1000 is directed to a particular brand of shoes. However, the advertisement 1000 includes textual content that can be classified in one or more preference classifications. More particularly, the textual content found in boxes 1002-1008 include subject matter that is not particularly directed to shoes but, instead, directed to various classifications to induce the consumer (i.e. the computer user) to purchase the advertised items. More particularly, the phrase “perform your best” as found in box 1002, is likely included in the advertisement 1000 to appeal to the computer user's desire to achieve optimal physical performance. Alternatively, the phrase “top-rated” as found in box 1004 is likely included in the advertisement 1002 convinced the computer user that the advertised product is the best product available. Similarly, advertisement 1100 includes phrases such as “factory-direct” as found in box 1102 and “factory direct advantage” as found in box 1104, each of which are likely included to convince the computer user that the advertised provider offers a competitive advantage over other providers. Through analysis of the selected advertisement and advertisement classification vector which includes elements that indicate which preference classifications may be found in the selected advertisement.

At block 510, a determination is made as to the computer user's interaction with the selected advertisement. By determining whether the computer user has interacted with the particular advertisement and aggregating the interactions of the computer user according to preference classifications, a profile or a preference classification vector for the computer user may be generated. Thus, after determining the computer user's interaction with selected advertisement, at block 512 interaction scores for the various classifications of the advertisement, as indicated in the advertisement classification vector, can be generated. As part of the iteration, at block 514, if there is another advertisement to iterate through the process returns to block 506 as described above with regard to the next advertisement. Alternatively after having iterated through all of the advertisements, the routine 500 proceeds to block 516.

At block 516, and an aggregation of the various user interactions with regard to the advertisements is made, thereby generating aggregate interaction scores for the computer user with regard to various preference classifications. At block 518, the aggregate scores are normalized such that they can be represented in a user preference vector as described above. Accordingly, at block 520, the normalized scores are stored in the user preference vector for the user. According to aspects of the disclosed subject matter, the aggregate interaction scores may be normalized such that it indicates the user's likelihood of interaction with an advertisement of the corresponding preference classification (or classifications) based solely on the user's prior interaction with presented advertisements. In other words, the normalized score of each preference classification of a user preference vector may be determined according to the user's interaction rate with regard to an advertisement of the preference classification. Alternatively, the aggregate interaction scores may be normalized such that it indicates the user's likelihood of interaction with an advertisement of the corresponding preference classification (or classifications) in relation to aggregate interaction scores of a plurality of other users. In this regard, the normalized score of each preference classification of a user preference vector may be determined according to the user's interaction rate with regard to an advertisement of the preference classification relative to the interaction rate of a plurality of users with regard to an advertisement of the preference classification.

After normalizing the scores and recording these in the user's preference vector, routine 500 terminates.

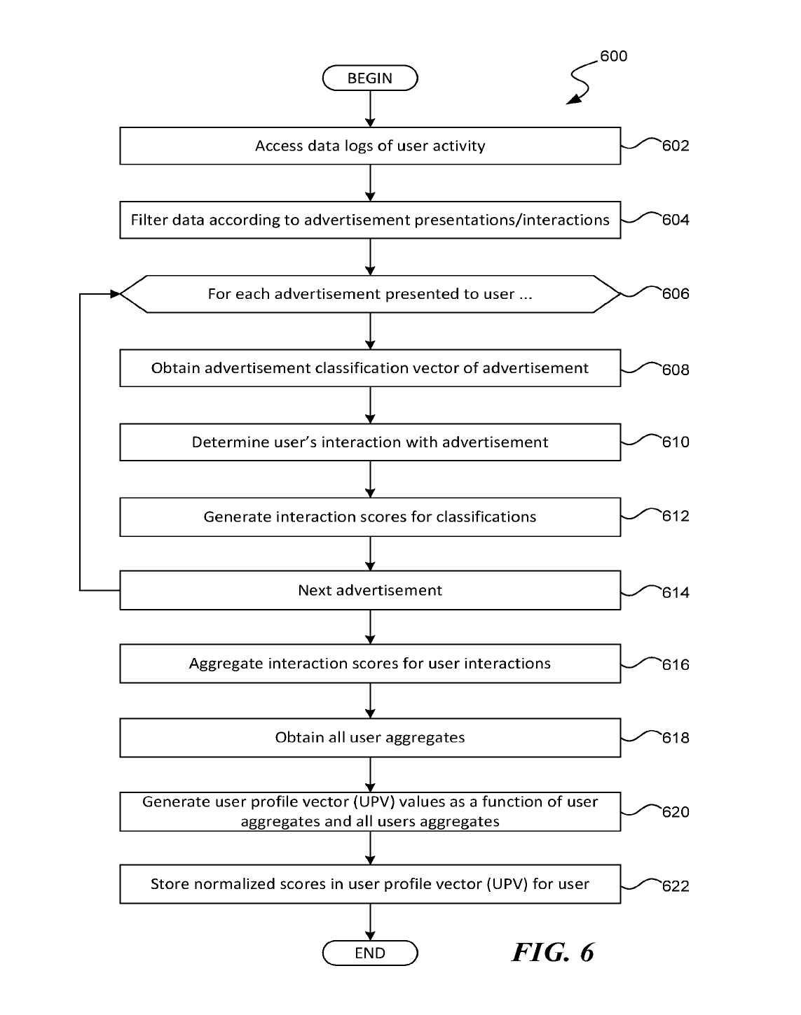

Turning now to FIG. 7, FIG. 7 is flow diagram illustrating an exemplary routine 700 for identifying modification content in accordance with aspects of the disclosed subject matter. The modification content corresponds to that content discussed above in regard to FIG. 4, i.e., content used to modify advertisements in order to add content corresponding to a preference classification to increase the likelihood that a computer user will interact with the advertisement. Beginning at block 702, a corpus of advertisements is accessed. The advertisement corpus corresponds to a large collection of advertisements from which an analysis may be made, as described below. At block 704, an iteration loop is begun to iterate through each of the advertisements in the advertisement corpus.

At block 706, a filtering process is commenced to filter out from the advertisement any specific references, query terms, keywords and the like that are directed to the particular subject matter of the advertisement. With reference again to FIG. 10, the exemplary results of filtering advertisement 1000 would leave the terms/phrases found in boxes 1002-1008, with the remainder being filtered out. As can be seen, the text/phrases in boxes 1002-1008 are not descriptive of any particular advertisement, such as advertisement 1000, but are included in the advertisement by the advertisers in order to entice the viewer of the advertisement to interact with the advertisement.

After filtering out all of the specific terms as discussed above, at block 706 the exemplary routine generates content patterns (n-grams) from the remaining content. Hence, with reference to FIG. 10, and n-gram may be generated from the words in box 1002, “Perform your best.” After generating engrams from the content that was not filtered from the advertisement, at block 710 and consistent with the iteration the routine 700 returns to block 704 if there any additional advertisements to be iterated. In the alternative, if there are no more additional advertisements to process, the routine 700 proceeds to block 712.

At block 712, the various content patterns generated in block 708 are clustered according to various clustering algorithms. Clustering algorithms are known in the art, such as Jacquard similarity clustering algorithms and the like. After clustering the content patterns, at block 714 the content patterns are classified according to preference classifications. Thereafter, at block 716, the content pattern clusters are stored in association with the preference classifications in a content modification store as suggested above. Thereafter, the routine 700 terminates.

Regarding routines 300-700, while these routines/processes are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 300-700 may be carried out in parallel or in series. Often, but not exclusively, the functionality of the various routines is embodied in software (e.g., applications, system services, libraries, and the like) that is executed on computing hardware and/or systems as described below in regard to FIG. 8. In various embodiments, all or some of the various routines may also be embodied in hardware modules, including but not limited to system on chips, specially designed processors and or logic circuits, and the like on a computer system.

These routines 300-700 are typically may be implemented in executable code comprising routines, functions, looping structures, selectors such as if-then and if-then-else statements, assignments, arithmetic computations, and the like. The exact implementation of each of the routines is based on various implementation configurations and decisions, including programming languages, compilers, target processors, operating environments, and the link. Those skilled in the art will readily appreciate that the logical steps identified in these routines may be implemented in any number of manners and, thus, the logical descriptions set forth above are sufficiently enabling to achieve similar results.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions store stored on the computer-readable storage devices are executed, they carry out various steps, methods and/or functionality, including those steps, methods, and routines described above in regard the various routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

FIG. 8 is a block diagram illustrating an exemplary advertisement service 800 implemented on a computer system and suitable for responding to advertisement requests. The exemplary computer system 800 includes a processor 802 (or processing unit) and a memory 804 interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM and memory storage devices and/or cards are examples of non-volatile memory 808.

The processor 802 executes instructions retrieved from the memory 804 in carrying out various functions, particularly in regard to implementing an advertisement service as described above. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: desktop computers, mini- and mainframe computers, multi-computer systems, distributed computer systems, and the like; etc.

The system bus 810 provides an interface for the various components of the mobile device to inter-communicate. The system bus 810 can be of any of several types of bus structures that can interconnect the various components (including both internal and external components). The advertisement service 800 further includes a network communication component 812 for interconnecting the advertisement service/computer system 800 with other computers and/or network entities (including, but not limited to, user computers such as user computers 102-104, content publishers 108-110, and advertisers 112-114) as well as other devices on the computer network 106. The network communication component 812 may be configured to communicate with the various computers and devices over the network 106 via a wired connection, a wireless connection, a physical connection or any combination of these.

The advertisement service 800 includes a user preference vector generator 814. The user preference vector generator 814 generates a user preference vector (as described above in regard to routine 500 of FIG. 5) for a plurality of computer users. The user preference vectors are stored in a user profile store 822 in association with the corresponding users and are retrieved when personalizing/modifying an advertisement in response to an advertisement request in order to increase the likelihood of user interaction with the requested advertisement.

The advertisement request interface 818 receives advertisement requests from requesting computer users, often in conjunction with the display of requested content from a content publisher. As described in regard to routine 400 of FIG. 4, the advertisement request relies upon the advertisement selector 826 to select an advertisement for display to the requesting computer user from an advertisement store 824. Selecting an advertisement in response to an advertisement request is known in the art. In addition to selecting an advertisement via the advertisement selector 826, the advertisement request interface 818 relies upon the advertisement modifier 816 to modify or personalize the selected advertisement in order to increase the likelihood that the requesting computer user will interact with the selected (and modified) advertisement. The advertisement modifier 816 uses content modifications (as discussed above in regard to routine 400 of FIG. 4) from a content modification store 826 in modifying the selected advertisement.

The advertisement service 800 further includes an advertiser interface 820. Advertisers, such as advertisers 112-114, interface with the advertisement service 800 to identify advertisement campaigns that include their various advertisements. These advertisement may include various modifications that may be made, according to aspects of the disclosed subject matter, preferences with regard to which preference classifications the modifications should be made, and the like.

Regarding the various components of the exemplary advertisement service 800, those skilled in the art will appreciate that these components may be implemented as executable software modules stored in the memory of the computing device, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to an advertisement request, the method comprising:
receiving an advertisement request for an advertisement for display to a computer user;
selecting an advertisement from a plurality of advertisements;
accessing a user preference vector associated with the computer user;
determining a modification action to be performed on the selected advertisement as a function of the user preference vector;
modifying the content of the selected advertisement according to the modification action; and
returning information for displaying the modified selected advertisement in response to the advertisement request.

2. The method of claim 1, wherein the user preference vector includes a plurality of preference classification items corresponding to each of a plurality of preference classifications, and wherein each preference classification item includes an indication of likelihood that the computer user will interact with an advertisement of the corresponding preference classification.

3. The method of claim 2, wherein the indication of likelihood that the computer user will interact with an advertisement of the corresponding preference classification comprises a magnitude of likelihood that the computer user will interact with an advertisement of the corresponding preference classification.

4. The method of claim 3, wherein the user preference vector includes a multi-classification item, the multi-classification item corresponding to a combination of least two of the plurality of preference classifications and including an indication of likelihood that the computer user will interact with an advertisement of the corresponding at least two preference classifications.

5. The method of claim 4, wherein determining a modification action as a function of the user preference vector comprises:
determining a set of potential modifications for the selected advertisement, wherein each potential modification corresponds to at least one preference classification;
for each potential modification, determining a score according to a user preference item of the user preference vector, the user preference item corresponding to the at least one preference classification of the potential modification action;
selecting the potential modification with the highest determined score;
obtaining modification content corresponding to the at least one preference classification of the selected potential modification; and
modifying the selected advertisement with the obtained modification content.

6. The method of claim 5, wherein the set of potential modifications are obtained from the advertiser and associated with the selected advertisement in an advertisement store.

7. The method of claim 6 further comprising:
analyzing online behavior data identifying the computer user's interactions with advertisements presented to the computer user in the context of the computer user's online activities to determine a likelihood of interaction of the computer user with an advertisement of a plurality of preference classifications; and
updating the computer user's user preference vector according to analysis of the online behavior data.

8. The method of claim 7, where the likelihood of interaction of the computer user with an advertisement of a plurality of preference classifications is based on the computer user's interactions with the advertisements presented to the computer user in relation to a plurality of computer users' interaction with the advertisements.

9. The method of claim 5, wherein obtaining modification content corresponding to the at least one preference classification of the selected potential modification comprises obtaining modification content corresponding to the at least one preference classification from a plurality of modification content corresponding to the at least one preference classification options having the highest rate of user interaction.

10. A computer-readable medium bearing computer-executable instructions which, when executed on a computing system comprising at least a processor and a memory, carry out a method for responding to an advertisement request, the method comprising:
receiving an advertisement request for an advertisement for display to a computer user;
selecting an advertisement from a plurality of advertisements;
accessing a user preference vector associated with the computer user;
determining a modification action to be performed on the selected advertisement as a function of the user preference vector;
modifying the content of the selected advertisement according to the modification action; and
returning information for displaying the modified selected advertisement in response to the advertisement request.

11. The computer-readable medium of claim 10, wherein the user preference vector includes a plurality of preference classification items corresponding to each of a plurality of preference classifications, and wherein each preference classification item includes an indication of likelihood that the computer user will interact with an advertisement of the corresponding preference classification.

12. The computer-readable medium of claim 11, wherein the indication of likelihood that the computer user will interact with an advertisement of the corresponding preference classification comprises a magnitude of likelihood that the computer user will interact with an advertisement of the corresponding preference classification.

13. The computer-readable medium of claim 12, wherein the user preference vector includes a multi-classification item, the multi-classification item corresponding to a combination of least two of the plurality of preference classifications and including an indication of likelihood that the computer user will interact with an advertisement of the corresponding at least two preference classifications.

14. The computer-readable medium of claim 13, wherein determining a modification action as a function of the user preference vector comprises:
determining a set of potential modifications for the selected advertisement, wherein each potential modification corresponds to at least one preference classification;
for each potential modification, determining a score according to a user preference item of the user preference vector, the user preference item corresponding to the at least one preference classification of the potential modification action;
selecting the potential modification with the highest determined score;
obtaining modification content corresponding to the at least one preference classification of the selected potential modification; and
modifying the selected advertisement with the obtained modification content.

15. The computer-readable medium of claim 14, wherein the set of potential modifications are obtained from the advertiser and associated with the selected advertisement in an advertisement store.

16. The computer-readable medium of claim 15, wherein the method further comprises:
analyzing online behavior data identifying the computer user's interactions with advertisements presented to the computer user in the context of the computer user's online activities to determine a likelihood of interaction of the computer user with an advertisement of a plurality of preference classifications; and
updating the computer user's user preference vector according to analysis of the online behavior data.

17. The computer-readable medium of claim 16, where the likelihood of interaction of the computer user with an advertisement of a plurality of preference classifications is based on the computer user's interactions with the advertisements presented to the computer user in relation to a plurality of computer users' interaction with the advertisements.

18. The computer-readable medium of claim 14, wherein obtaining modification content corresponding to the at least one preference classification of the selected potential modification comprises obtaining modification content corresponding to the at least one preference classification from a plurality of modification content corresponding to the at least one preference classification options having the highest rate of user interaction.

19. An advertisement service implemented on a computer system for responding presenting search results to an advertisement request, the computer system comprising a processor and a memory, wherein the processor executes instructions stored in the memory as part of or in conjunction with additional components of the advertisement service to respond to the advertisement request, the additional components comprising:
an advertisement request interface for receiving the advertisement request for an advertisement to be presented to a requesting computer user;
an advertisement selector for selecting an advertisement from a plurality of advertisements in an advertisement store in response to the advertisement request; and
an advertisement modifier that:
identifies a modification from a plurality of modifications to the advertisement as a function of a user preference vector corresponding to the requesting computer user;
obtains modification content from a modification content store; and
modifies the selected advertisement with the obtained modification content;
wherein the advertisement service returns the modified selected advertisement to the requesting computer user in response the advertisement request.

20. The advertisement service of claim 19, wherein the user preference vector includes a plurality of preference classification items corresponding to each of a plurality of preference classifications, and wherein each preference classification item includes an indication of likelihood that the computer user will interact with an advertisement of the corresponding preference classification.
